(19) United States
(12) Patent Application Publication
(10) Pub. No.: US 2003/0028618 A1
(43) Pub. Date: Feb. 6, 2003

(54) Automated publishing content procurement

(76) Inventors: Kevin G. Currans, Philomath, OR (US); John A. Bertani, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/916,042

(22) Filed: Jul. 25, 2001

(51) Int. Cl. G06F 15/16

(52) U.S. Cl. 709/218; 709/219; 709/238

(57) ABSTRACT

Content for publication is obtained. Publishable content is stored within at least one content server. Each item of the publishable content includes specific criteria pertaining to publication of the item. A publishing system generates a request for publishing content. The request for publishing content includes requested criteria for the requested publishing content. The publishing system the requested publishing content to a service location system. The service location system uses the requested criteria for the requested publishing content to obtain first publishing content that satisfies the requested criteria from the at least one content server. The service location system returns the first publishing content to the publishing system.

### BACKGROUND

The present invention concerns using networks to provide business solutions and pertains particularly to automated publishing content procurement.

The vast majority of media outlets, such as newspapers, magazines, radio stations, television stations, are dependent upon advertisements for part or all of their operating income and profits. Use of advertisements is also a primary marketing tool for providers of products and services of all kinds.

Typically, advertisements are sold on a company to company basis. Companies providing a media outlet sell advertising space directly to companies supplying product or services. This can result in a substantial transaction cost both to companies soliciting advertisements and to companies looking for media outlets that are able to provide effected and targeted advertisements for the products and/or services.

### SUMMARY OF THE INVENTION

In accordance with the preferred embodiments of the present invention, content for publication is obtained. Publishable content is stored within at least one content server. Each item of the publishable content includes specific criteria pertaining to publication of the item. A publishing system generates a request for publishing content. The request for publishing content includes requested criteria for the requested publishing content. The publishing system forwards the requested publishing content to a service location system. The service location system uses the requested criteria for the requested publishing content to obtain first publishing content that satisfies the requested criteria from the at least one content server. The service location system returns the first publishing content to the publishing system.

Content servers can be, for example, arranged in a hub network configuration. For example, the publishable content contains print advertisements, recipes, music lyrics, radio spot advertisements and/or audio-visual advertisements. The content can be stored as meta data (tags associated with content) that dictates subsequent content. For example, a user that accesses country music content will in the future receive additional content targeted towards listeners of country music.

When the publishable content contains recipes, for example, the content servers include a recipe server that stores recipes and an advertisement server that stores advertisements. Additionally, another content server may be a cookbook repository server. The first publishing content includes, for example, a first recipe plus a reference to a book that contains the first recipe and/or one or more advertisements related to the first recipe. For example, if the first recipe is for a baked lasagna, a coupon for Mozzerella cheese.

When the publishable content contains advertisements, for example, the specific criteria includes a profile of a targeted audience, print quality of the content, and/or an acceptable cost of impressions. Print quality refers to size, color or resolution of the content.

The present invention expedites the response to queries for advertising or other publishable commodity items. The invention allows automated advertisement placement with personalization and cost per thousand impressions (CPM) criteria.

### BRIEF DESCRIPTION OF THE DRAWINGS

FIG. 1 shows an automated content procurement system implemented utilizing a hub style network in accordance with a preferred embodiment of the present invention.

FIG. 2 shows an automated content procurement system implemented utilizing a hierarchical organization of a hub style network in accordance with a preferred embodiment of the present invention.

FIG. 3 shows interactivity with an automated recipe/advertisement procurement system implemented utilizing a hub style network in accordance with a preferred embodiment of the present invention.

FIG. 4 is a simplified flowchart that illustrates operation of a publication system in accordance with a preferred embodiment of the present invention.

FIG. 5 is a simplified flowchart that illustrates operation of a service location system in accordance with a preferred embodiment of the present invention.

FIG. 6 is a simplified flowchart that illustrates operation of a content server in accordance with a preferred embodiment of the present invention.

### DESCRIPTION OF THE PREFERRED EMBODIMENT

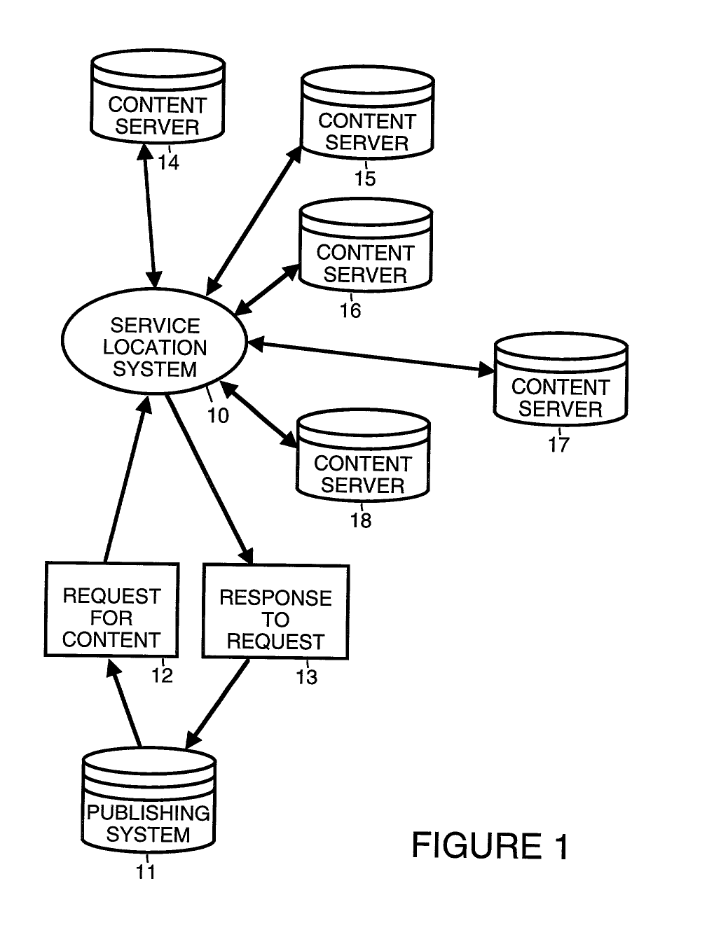

FIG. 1 shows an automated content procurement system implemented using a hub style network. A publishing system 11 recognizes that it needs specific content. The specific content is, for example, an advertisement, a recipe, a child's activity, music lyrics, a video clip, graphics, etc. The advertisement could be, for example, for print media, audio media (such as radio) or audio/visual media (such as television), depending upon media delivery type for the resulting document.

Publishing system 11 sends a request 12 for content to service location system 10. Specific information included in request 12 is, for example, a profile of the targeted audience for the content, size of the content, and acceptable CPM (Cost per 1000 impressions). In addition, there can be information about what the end user should not receive. Information about what the end user should not receive is, for example, built into a profile for the user. In addition, publishing system 11 can determine additional information about what the end user should not receive. For example, publishing system 11 may not want to continuously include the same advertisement in a user's publication; therefore, after a specific advertisement has been published once, publishing system 11 may exclude the specific advertisement from the same publication for a specified period of time (using a user profile maintained by the publishing system).

Service location system 10 sends request 12 on to content servers, represented in FIG. 1 by a content server 14, a content server 15, a content server 16, a content server 17 and a content server 18. The content servers return, to service location system 10, content that matches the database queries with the properties of the request.

Service location system 10 essentially acts as a brokerage for requests from publishing system 11. Service location system 10 keeps track of which content servers are available.

Service location system 10 is a service provider that has the capability of intelligent interaction. For example, service location system 10 is implemented using e-speak.net available on the internet at http://www.e-speak.net/. Using e-speak.net, servers can dynamically discover and negotiate with each other, can mediate on behalf of their users, and can compose themselves into more complex services. Request 12, for example, is made using a well-defined extensible mark-up language (XML) based ad server vocabulary and the ad server's public application programming interface (API). These requests are then transmitted to the content servers. Additionally, service location system 10 brokers the responses from the content servers and sends a single response 13 to publishing system 11. Service location system 10 can also include a content server.

Content servers can be connected to a service location system in various configurations. FIG. 1 shows content servers 15 through 18 connected to service location system 10 in a network hub configuration. Content servers 15 through 18 receive their requests directly from service location system 10.

In one preferred embodiment, there is a “time due” indicator on request for content 12. This time indicator is the time in which the service location system 10 will review all of the responses and pick the “best” advertisement to be sent on to publishing system 11 as response to request 13.

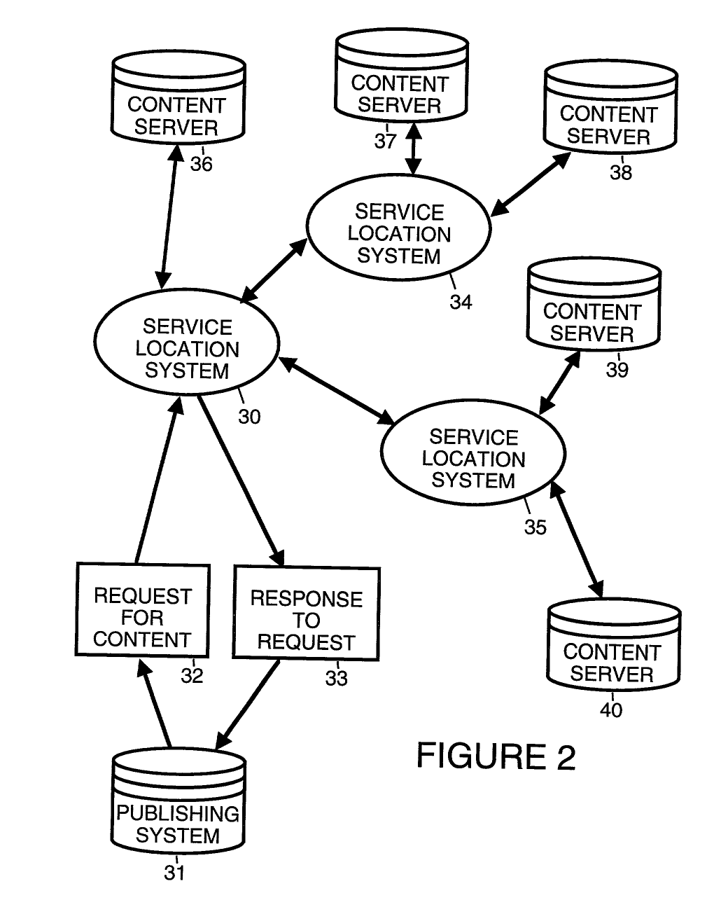

FIG. 2 shows a service location system 30, a service location system 34 and a service location system 35 configured into a hierarchical network. Service location system 30 access data directly from a content server 36. Service location system 34 accesses data directly from a content server 37 and a content server 38. Service location system 35 accesses data directly from a content server 39 and a content server 40. In addition, any of the service location systems can include an internal content server.

A publishing system 31 sends a request for content 32 to service location system 30. For example, request for content 32 is a specific request that includes requested criteria that sets out the acceptable CPM and the necessity to meet specific criteria in a profile for a user to whom obtained content is to be published.

Service Location system 30 forwards request for content 32 to content server 36. If content server 36 is unable to fulfill request for content 32, service location system 30 forwards request for content 32 on to service location system 34. Service Location system 34 forwards request for content 32 to content server 37 and content server 38. If content server 37 and content server 38 are unable to fulfill request for content 32, service location system 30 forwards request for content 32 on to service location system 35. Service Location system 35 forwards request for content 32 to content server 39 and content server 40. And so on. The first content server to satisfy request for content 32 is selected to supply content for a response to request 33 sent by service location system 30 to publishing system 31.

The hierarchical network type configuration of content servers shown in FIG. 2 works well when requesting responses based on locale. This configuration easily accommodates local advertisers, as well as national advertisers.

For example, a request for content could be for an advertisement that would fit into a one inch by two inch space. The request for content includes a user profile that contains demographic information. This demographic information is used by service location system 10 (shown in FIG. 1) or service location system 30 (shown in FIG. 2) when forwarding a request for content to other service location systems or content servers. The content servers can then respond with acceptable content. The service locator systems determine the content that best fits the criteria.

The content servers contain information about each potential piece of content. For example if the content is an advertisement, for each advertisement, the advertiser provides specific meta-data about the advertisement. For example, the meta-data indicates whether the advertisement is scalable. If the advertisement is scalable, the meta-data indicates how the CPM changes based on the printed size of the advertisement. The meta-data also indicates, for example, the content format for the advertisement. The meta-data can also indicate what demographics the advertisement targets, whether the advertisement is internationalized, whether there are translations available for different languages, and/or whether reading the advertisement would satisfy a radio spot. If the advertisement is a coupon, the meta-data indicates, for example, what demographic information is included. If the advertisement is a recipe, the meta-data, for example, includes the ingredients. And so on.

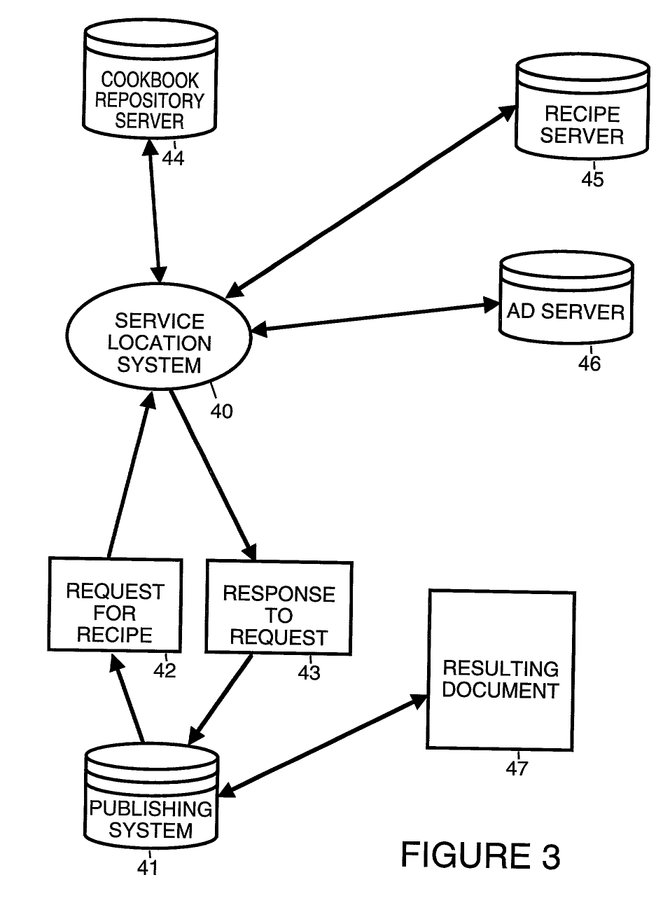

FIG. 3 shows a specific embodiment of the present invention where requests are made for recipes. A publishing system 41 sends a request for recipe 42 that satisfies specific criteria, e.g., vegetarian, low fat, casserole, stew, or some combination of these. In addition, request for recipe 42 indicates publishing system 41 would like a full page of related information. A service location system 40 forwards the request for recipe to one or more recipe servers, represented in FIG. 3 by a recipe server 45. From the available recipes in the recipe server(s), the “best” recipe is selected. Service location system 40 additionally requests information on a book containing that recipe from a cookbook repository server 44. Cookbook repository server 44 is, for example a commercial bookseller such as Barnes and Noble or Amazon.com. Service location system 40 can also, for example, query an advertiser server 46 for a coupon for some ingredients within the recipe. Service location system 40 can also obtain additional information about the recipe from one of the aforementioned server or from an additional server. The information obtained by service location system 40 is bundled and returned to publishing system 41 in a response to request 43. Publishing system 41 then constructs a resulting document 47 for use by the original requester of a recipe. For example, if the requester is an individual obtaining a recipe from a web site run by publishing system 41, document 47 may be a sheet that includes the recipe, several coupons, a section on cooking tips and tricks, information about the book from which the recipe was taken, and information about a television show or web site that provides audio-visual footage of a cook actually preparing the recipe.

Using this strategy, for example, cookbook publishers or book vendors can maintain recipe servers culled from the books they publish or sell.

The present invention can be extended to many other uses. For example, a request for music lyrics to a publishing system includes specific criteria for song lyrics. The specific criteria is, for example, a specific artist, a style of music and/or a song title. The service location system sends this information out to a lyric server. The lyric server, for example, also host books with lyrics and indicates where the host books could be purchased locally, or on-line. In addition, the lyric server, for example, contacts a concert server and inquires about concerts that might be of interest to the originator of the request. The concert listings are, for example, for local concerts or recent concerts that have “news-worthy” material. These additional contacts are all revenue streams for advertising.

The present invention can also be used for advertising creation for small businesses. For example, a business with a small budget for advertising could state that they are willing to pay a particular amount for an advertisement for their business that does floor refinishing. The business indicates a need for the final artwork in one month. In response to the request ad agencies could create an advertisement and if the floor refinishing company selected their advertisement, the ad agency receives the advertisement and, for example, a specified number of dollars per 1000 placements. This would encourage the graphic artists at the ad agencies to appeal to the largest audience with their ad.

Content can be delivered for publication in written documents. Alternatively, delivered content can be for display by personal digital assistants (PDAs), pagers, cell phones and/or other devices/appliances. Content could also be for delivery to television, radio and additional audio and/or visual media.

When the content is an advertisement to be viewed by subscribers to a publishing system, criteria, such as that listed below in Table 1, typically is included by the publishing system requesting the advertisement and/or the advertisement provider.

TABLE 1

Acceptable frequency of repeatability
Publications this ad should be or not be in
Content that this Ad should be near or not be near
Other Ads that this ad should or should not appear with
Local of ad. (distribution area for ad placement)
Expiration date of ad; 1st day ad can be placed
Price range advertiser is willing to pay for the ad placement
(range desired in the event of multiple candidates that
satisfy the criteria)
Meta-data containing search criteria
Preferred age group and sex, with center and diminishing
function
Language, countries
Interests: games, automobiles, etc.
Personal information if subscriber has granted permission to
use it
Ad preference-(If specified by a subscriber)

Table 2 below is an example of an API for a content server that is an ad server:

TABLE 2
ADserver API

| | |
|---|---|
| FindAd | Finds an advertisement that matches the criteria |
| | of the grammar posted and returns an XML Add |
| | reference |
| Find NextAd | Queries the content server for the next Ad. |
| | Passing the Ad reference from the last ad. The content |
| | server caches the initial Query, for “xx” minutes, and |
| | can reply quickly hand back another add |
| GetAd | This a post request with an Ad reference, |
| | specifying Resolution and size adjustments. |
| PostAd | submit an ad for serving |

Table 3 below is an example session in which a publishing system responds to a request for an advertisement:

TABLE 3
---------Find a Content server (Adserver)-------
--------Request to Adserver service---------
http:

POST/Adserver
HOST:hpcvxkcl.cv.hp.com:12345

Data:

<XML>

<ADserver Media=“print”>

<FindAD Age=“male”Locale=“97330” Age=“40”

Interest=“sports”>

</ADserver>

</XML>

--------A Single Adserver Reply:--------
ContentType=application/HPAdserver
<xml>
<HPADreference

display_units=dpi
resolutions available=“120,300”
href=“http://hpcvxkcl.cv.hp.com/Adserver?ADid=891375

6

Agency=“John and Kevin's wonderful Demos”>

</xml>
--------The publishing system performs processing------

-Filter the ads returned for Account/quota/promotion

requirements.

-Pick one.

--------Fetch the ad for print from the core-----
http:

GET

/ADserver?ADid=8913756+r=300+s=pnts+x=144+y=144

HOST hpcvxkcl.cv.hp.com:8001

--------Ad reply-------

ContentType= image/jpeg
jpeg image that is for print 2″×2″ with 300 dpi resolution)

Table 4 below is an example a reference for an advertisement within a content server (ad server). The references is in an extensible mark-up language (XML):

TABLE 4
XML Ad Reference:

ADid - The ADid is assigned by the adserver and is
unique to the ads handled by the content server.
Grammar:

Age: 0-999
Sex: M/F
Locale: zip
Interest: (sports|family|medical|entertainment|news)
Media: (html|print|audio|video)
Href: URL that points to add servers specifying

ADID/size/resolution/imagetype
(s)size: (pix)pixels/(pts)points
(r)resolution: #dpi
(it)imagetype: jpeg/tiff/qif/eps
(x)dimension: units of size
(y)dimension: units of size
(r)rating G, PG, R, NR, PG13, PG13+
(t)Topic: Smoking, sailing, fishing, biking . . .
PlacingCriteria:

/*Not by other adds that match this criteria

Notby=“Environmental”+“conservation”
Notby=“Ace Hardware Co”

Result codes:

Success Ad
No Such Ad
Adserver Not found
Adserver not responding

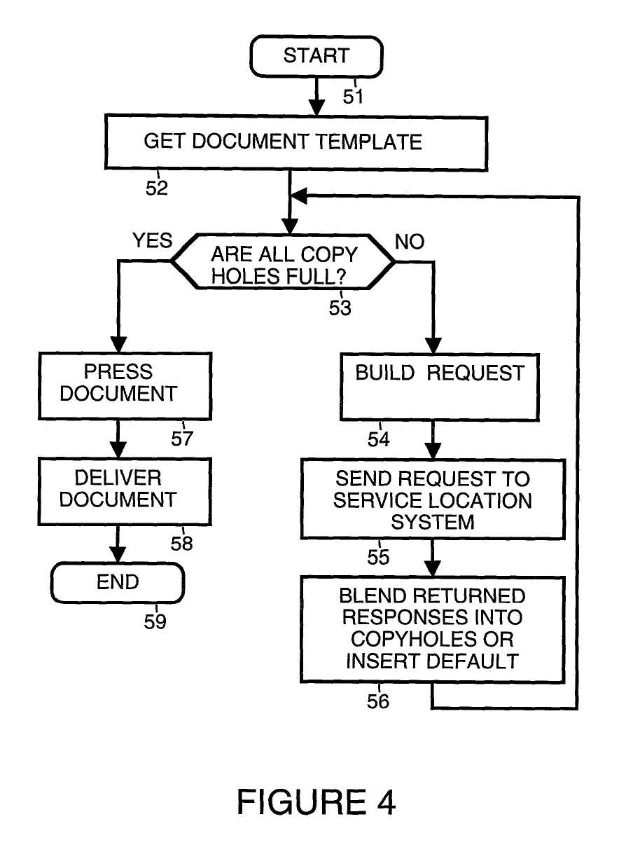

FIG. 4 is a simplified flowchart that illustrates operation of a publication system. In a step 51, the publication system begins work on a document. In a step 52, a document template is obtained. In a step 53 a check is made to see whether all copy holes in the document are full. If not, in a step 54, a request is built for one or more copy holes. The request includes information such as user profile data, metatags from copy holes, size of copy holes and/or media type of document.

In a step 55, the request is sent to a service location system. In a step 56, returned responses are blended into copy holes. Alternatively, default data may be placed in a copy holes.

In step 53, a check is again made to see if all copy holes are full. If all copy holes are full, in a step 57, the document is pressed (i.e., completed). In a step 58, the document is delivered. In a step 59, the publication has completed work on the document.

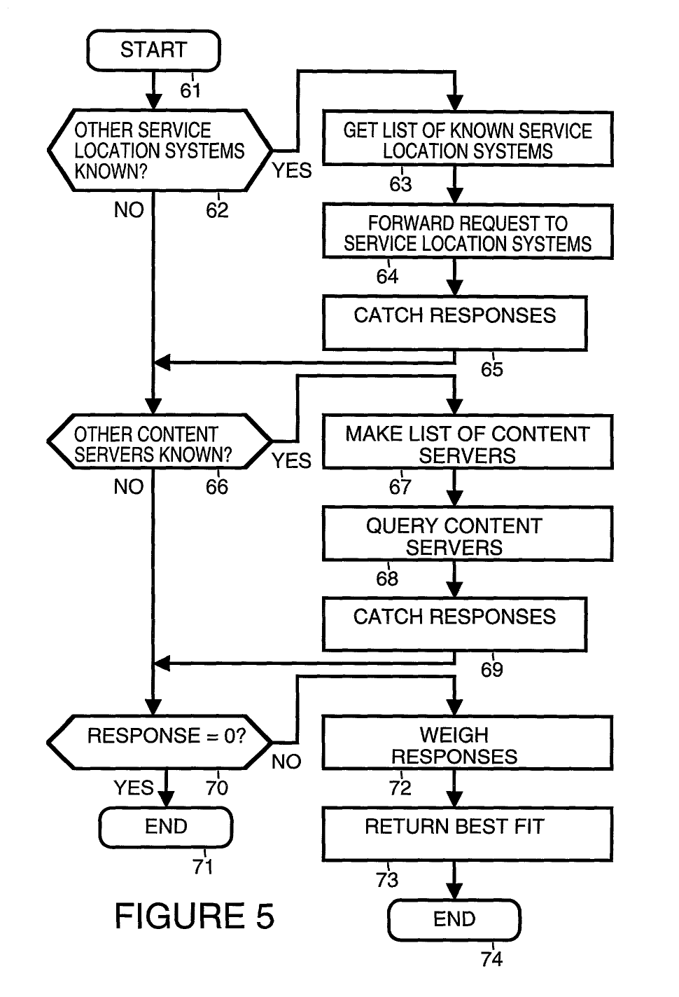

FIG. 5 is a simplified flowchart that illustrates operation of a service location system. In a step 61, the service location system begins work on a request. In a step 62, the service location system determines whether other service location systems are known. If so, in a step 63, a list of known service location systems is made. In a step 64, the request is forwarded to the known service location systems. In a step 65, responses from the known service location systems are caught.

In a step 66, the service location determines whether other content servers are known. If so, in a step 67, a list of known content servers is made. In a step 68, the known content servers are queried based on the request. In a step 69, responses from the known content servers are caught.

In a step 70, the service location determines whether there were any responses. If there were no responses, in a step 71, the service location returns to the entity that called it an indication that there is no suitable response. If there were responses, in step 72, the service location weighs the responses. In a step 73, the service location system returns a best fit from the responses. In a step 74 the service location system has completed work on the request.

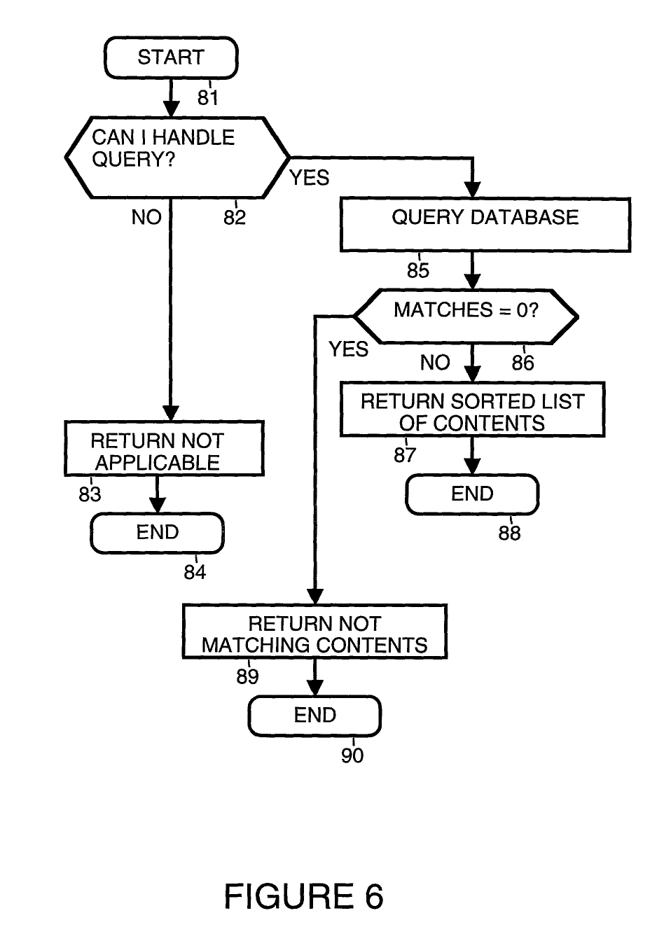

FIG. 6 is a simplified flowchart that illustrates operation of a content server. In a step 81, the content server begins work on a query. In a step 82, the content server determines whether the content server can handle the query. If not, in a step 83, the content server returns a response indicating the query is not applicable. In a step 84 the content server has completed work on the query.

If in step 82 the content server determines it can handle the query, in a step 85 the content server queries the appropriate database(s). In a step 86, the content server determines whether there are any matches. If there are no matches, in a step 89, the content server returns a response indicating there are no matches for the query. In a step 90, the content server has completed work on the query.

If in step 86 the content server determines there are matches, in a step 87, the content server prepares a response including a sorted list of contents. In a step 88, the content server has completed work on the query.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A method for obtaining content for publication, the method comprising the following steps:
(a) storing publishable content within at least one content server, each item of the publishable content including specific criteria pertaining to publication of the item;
(b) generating, by a publishing system, a request for publishing content, the request for publishing content including requested criteria for the requested publishing content;
(c) sending, by the publishing system to a service location system, the requested publishing content;
(d) using, by the service location system, the requested criteria for the requested publishing content to obtain from the at least one content server, first publishing content that satisfies the requested criteria; and,
(e) returning from the service location system to the publishing system the first publishing content.

2. A method as in claim 1 wherein in step (a) the publishable content contains one of the following:
print advertisements;
recipes;
music lyrics;
radio spot advertisements; and,
audio-visual advertisements.

3. A method as in claim 1 wherein in step (a) the at least one content server includes a plurality of content servers arranged in a hub network configuration.

4. A method as in claim 1 wherein in step (a) the at least one content server includes a plurality of content servers arranged in a hierarchical network configuration.

5. A method as in claim 1 wherein in step (a):
the publishable content contains recipes; and,
the at least one content server includes a recipe server that stores recipes and an advertisement server that stores advertisements.

6. A method as in claim 5 wherein in step (a):
the at least one content server additionally includes a book repository server.

7. A method as in claim 6 wherein in step (e):
the first publishing content includes a first recipe plus a reference to a book that contains the first recipe.

8. A method as in claim 5 wherein in step (e):
the first publishing content includes a first recipe plus at least one advertisement related to the first recipe.

9. A method as in claim 1 wherein in step (a):
the publishable content contains advertisements; and,
the specific criteria includes at least one of the following:
a profile of a targeted audience,
print quality of the content, and
acceptable cost of impressions.

10. A method for obtaining content for publication, the method comprising the following steps:
(a) generating, by a publishing system, a request for publishing content, the request for publishing content including requested criteria for the requested publishing content;
(b) sending, by the publishing system to a service location system, the requested publishing content;
(c) using, by the service location system, the requested criteria for the requested publishing content to obtain from at least one content server, first publishing content that satisfies the requested criteria; and,
(d) returning from the service location system to the publishing system the first publishing content.

11. A system for obtaining content for publication, the system comprising:
a publishing system that generates a request for publishing content, the request for publishing content including requested criteria for the requested publishing content; and,
a service location system for receiving the request for publishing content from the publishing system, the service location system using the requested criteria for the requested publishing content to obtain from at least one content server first publishing content that satisfies the requested criteria, the service location system returning the first publishing content to the publishing system.

12. A system as in claim 11 wherein the publishable content contains one of the following:
print advertisements;
recipes;
music lyrics;
radio spot advertisements; and,
audio-visual advertisements.

13. A system as in claim 11 wherein the at least one content server includes a plurality of content servers arranged in a hub network configuration.

14. A system as in claim 11 wherein the at least one content server includes a plurality of content servers arranged in a hierarchical network configuration.

15. A system as in claim 11 wherein:
the publishable content contains recipes; and,
the at least one content server includes a recipe server that stores recipes and an advertisement server that stores advertisements.

16. A system as in claim 15 wherein:
the at least one content server additionally includes a book repository server.

17. A system as in claim 16 wherein:
the first publishing content includes a first recipe plus a reference to a book that contains the first recipe.

18. A system as in claim 15 wherein:
the first publishing content includes a first recipe plus at least one advertisement related to the first recipe.

19. A system as in claim 11 wherein:
the publishable content contains advertisements; and,
the requested criteria includes at least one of the following:
a profile of a targeted audience,
print quality of the content, and
acceptable cost of impressions.

20. A system as in claim 11 wherein the publishing content is for display on at least one of the following devices:
personal digital assistants (PDAs);
pager;
